(19) United States
(12) Patent Application Publication
(10) Pub. No.: US 2026/0119132 A1
(43) Pub. Date: Apr. 30, 2026

(54) FUNCTIONAL CODE GENERATION AND APPLICATION EXTENSIBILITY SYSTEM LEVERAGING LLM CAPABILITIES

(71) Applicant: SAP SE, Walldorf (DE)

(72) Inventors: Mingkang HUANG, Shanghai (CN); Gancheng QIU, Shanghai (CN); Yudi LOU, Shanghai (CN); Zhehui XIA, Shanghai (CN)

(21) Appl. No.: 18/925,168

(22) Filed: Oct. 24, 2024

(51) Int. Cl. G06F 8/35

(52) U.S. Cl. CPC G06F 8/35

(57) ABSTRACT

System, method, and various embodiments for a functional code generation system leveraging LLM capabilities, are described herein. An embodiment operates by receiving a request to add new functionality to an application. A vector prompt is generated for a large language model (LLM) to generate a vector including one or more technical attributes associated with the request. The vector is compared to the vector database to identify a first module, of the plurality of modules, that is associated with the one or more technical attributes associated with the request. A code prompt is generated for the LLM, wherein the LLM is configured to generate new code for the new functionality using the first module. The new code including the first module corresponding to the new functionality is provided responsive to receiving the request.

### BACKGROUND

It is a highly technical, time consuming, and resource consuming process to add new functionality to existing application. This process involves coding, compiling, testing, troubleshooting, and revising by highly skilled technical professionals repeatedly until the correct functionality has been added. Because of the computing resources required and the various technical challenges involved, performing these application updates is generally unavailable to the end users of the application, particularly those without a technical background. However, this becomes problematic because without the ability to add new functionality to an application, the application may not meet the needs of an end user.

### BRIEF DESCRIPTION OF THE DRAWINGS

The accompanying drawings are incorporated herein and form a part of the specification.

FIG. 1 is a block diagram illustrating example functionality for a functional code generation system (FGS), according to some embodiments.

FIG. 2 is a flowchart illustrating example operations for providing a functional code generation system (FGS), according to some embodiments.

FIG. 3 is example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing a functional code generation and application extensibility system leveraging large language model (LLM) capabilities.

It is a highly technical, time consuming, and resource consuming process to add new functionality to existing application. This process involves coding, compiling, testing, troubleshooting, and revising by highly skilled technical professionals repeatedly until the correct functionality has been added. Because of the computing resources required and the various technical challenges involved, performing these application updates is generally unavailable to the end users of the application, particularly those without a technical background. However, this becomes problematic because without the ability to add new functionality to an application, the application may not meet the needs of an end user.

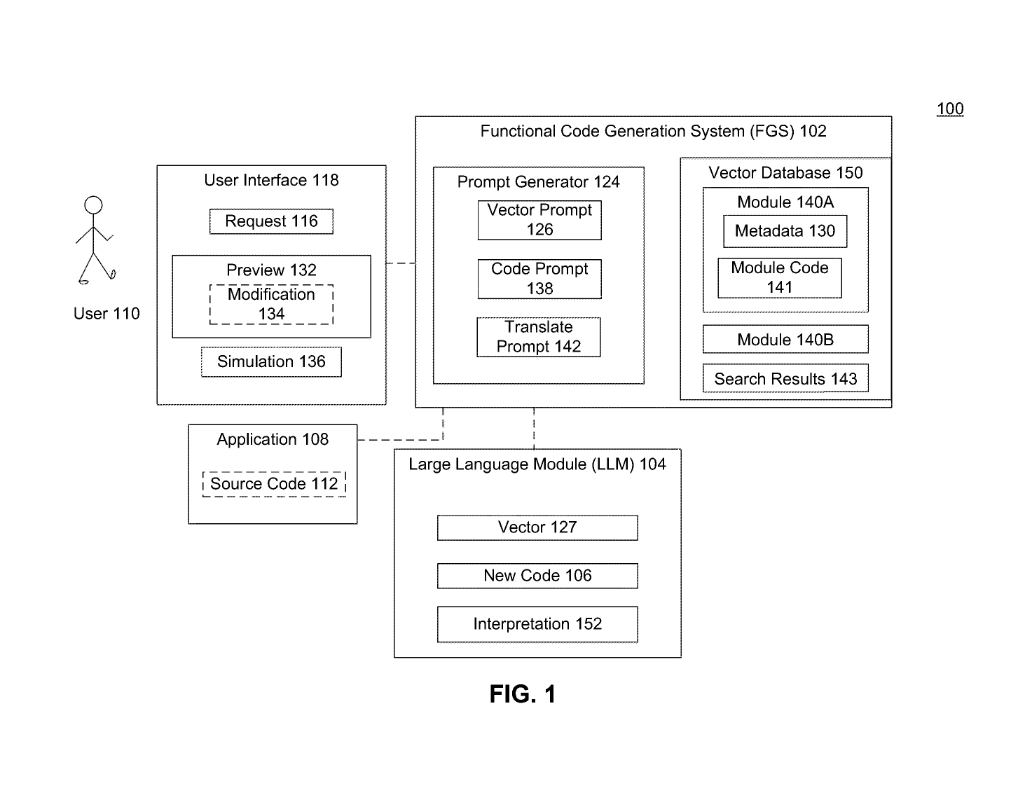

FIG. 1 is a block diagram 100 illustrating example functionality for a functional code generation system (FGS) 102, according to some embodiments. FGS 102 may leverage the processing capabilities of a large language model (LLM) 104 to allow a non-technical user 110 to add new functionality to (or otherwise updating) an application 108, in a process which may include generating new code 106. FGS 102 may allow the user 110 to perform such updates without requiring the user 110 to perform any coding themselves or waiting for a developer to perform the coding updates in a resource consuming back-and-forth process. Instead, FGS 102 may allow the user 110 to leverage the coding capabilities of an LLM 104 to generate the changes for the application 108, and allow the user 110 to review and approve the new code 106, and deploy the update to the application 108. In some embodiments, FGS 102, as described herein, may be directed to extending application functionality by leveraging LLM capabilities to facilitate update and customizations in enterprise applications.

FGS 102 provides significant computational advantages over traditional code development processes which requiring back-and-forth communications between different users and multiple versions of code updates which would need to be manually performed, compiled, and tested. FGS 102 streamlines this process, and enables the user 110 to use plain language (e.g., non-programming language) instructions to cause FGS 102 perform the requested updates to an application 108. As is discussed in greater detail below, FGS 102 further streamlines the code development process by reusing existing modules 140 in adding the new functionality requested by a user 110.

In some embodiments, the user 110 may submit a request 116 via user interface 118. The request 116 may include a plain language, non-computing language or non-programming language, instructions indicating what functionality the user 110 wants to add to the application 108. FGS 102 allows the user 110 to submit a request 116 using spoken language or text, without any knowledge of programming, to add new functionality to an application 108. For example, the user 110 may describe the new functionality that the user 110 wants added to the application 108.

Application 108 may include any computer program, application, web application, or app, that includes user facing functionality which may be updated. In some embodiments, the application 108 may include source code 112. Source code 112 may include any computing code written across one or more computing or programming languages which is used to execute application 108 (which may be done after compiling the source code 112). In some embodiments, source code 112 may be stored or executed across multiple files or computing devices. In some embodiments, application 108 may include an application operating in a cloud or other network-based environment, which may be accessible to one or more users. In some embodiments, updating the functionality of application 108 may include updating the source code 112 of the application 108. FGS 102 leverages an extensive library of pre-existing modules 140 to expedite code development and minimize errors.

In some embodiments, user 110 may be a non-technical or end user of application 108, who may not be familiar with how to write code or update source code 112. In some embodiments, user 110 may want to update some functionality in application 108. For example, user 110 may want to add new functionality to application 108. In some embodiments, user 110 may not have authorization or permission to directly access and update source code 112.

However, without knowing how to or even having permissions to modify source code 112 and/or without the computing resources which may be necessary to develop, compile and test code modifications, user 110 may not be able to update the application 108. Instead, a user would have to wait for a developer to perform an update of the application, and hope the developer updates in the application in the manner desired by the user. If the developer misunderstands the user or does not properly perform the update, there may be multiple back and forth interactions with the developer, and multiple compilation and testing sessions, thus wasting valuable time and computing resources. FGS 102 both eliminates the need for a user 110 to have deep technical knowledge and reduces the dependency on traditional coding which is both resource consuming and time consuming.

FGS 102 allows for a non-technical user 110 to update application 108, without any prior knowledge of programming or how to update source code 112. In some embodiments, user 110 may not be authorized to directly access or update source code 112. FGS 102 may allow a user 110 to directly communicate a request 116 to FGS 102 using plain language or natural language. FGS 102 may then perform updates on the behalf of user 110. FGS 102 obviates the need for a developer or even development background by the user 110 to update the source code 112 of application 108.

Upon receiving the update request 116, a prompt generator 124 may generate one or more prompts for LLM 104 to perform some functionality involved in generating a response to the request 116. A prompt may include one or more lines of text organized across one or more documents that is particularly formatted to by understandable by a large language model (LLM) 104. LLM 104 may include an artificial intelligence, machine learning, or deep learning model that is configured to execute data processing commands from plain-text (e.g., not requiring computer language or coded input). LLM 104 may include any computing system that is configured to perform processing tasks based on text-based or plain language inputs. LLM 104 may be configured to create original content from one or more documents or input in accordance with a prompt. In some embodiments, LLM 104 may include a generative pre-training transformer (GPT).

Example prompts which may be generated by prompt generator 124 include a vector prompt 126, code prompt 138, and translate prompt 142. In other embodiments, different or additional prompts may be generated.

In some embodiments, the vector prompt 126 may be used to cause LLM 104 to interpret or translate the request 116 into one more technical commands and/or extract keywords that are associated with the new functionality being requested by user 110. Because the user 110 may use natural language in request 116, the request 116 may include words that are not directly associated with new functionality (such as “I want to add new functionality that…”). The vector prompt 126 may cause LLM 104 to strip away the words that are not directly associated with the new functionality requested by user 110, and identify more precisely what functionality the user 110 is requesting.

In some embodiments, the vector prompt 126 may include the request 116 as input, and may request LLM 104 to generate as output a vector 127. Vector 127 may include a translation of the request 116 into one or more technical commands and/or keywords. LLM 104 may be trained to perform initial NLP (natural language processing) on the instructions provided by user 110 via request 116 (or other user input) to generate the vector 127. Through leveraging the capability to LLM 104 to understand or translate natural language, FGS 102 obviates the need for a developer or even development background by the user 110 to update the application 108. The vector 127 may be used by FGS 102 to identify any pre-built functionality that could be added to satisfy at least a portion of the request 116 by user 110.

Rather than developing new functionality from scratch, FGS 102 leverages one or more pre-existing modules 140 to help further expedite the code development process and reduce the number of errors that may occur during code development, and consume less computing resources, which may increase the overall system throughput and create more uniform and reliable, easier to maintain code updates. The vector 127, generated by LLM 104, may help FGS 102 identify the most relevant or most closely corresponding module(s) 140 to the request 116 that include at least a portion of the new functionality being requested by user 110.

For example, request 116 may be “I want to add data verification functionality to the application to verify the correctness of a sales order”. The resultant vector 127 may include the keywords of: data verification, sales order. In some embodiments, FGS 102 may then perform a search on a vector database 150 for any modules 140A, 140B (referred to herein generally as module 140 or modules 140), associated with or corresponding to the “data verification” and/or “sales orders” of vector 127. In some embodiments, the similarity search may be performed using Euclidean distance, Cosine distance, Manhattan distance, Jaccard distance, or Mahalanobis distance to compare the similarity between vector 127 and a given entry corresponding to a module 140 in vector database 150. The identified module(s) 140 may be returned as search result 143, as the module(s) 140 which may include at least a portion of the functionality being requested in request 116.

Vector database 150 may include a library or other storage of a plurality of modules 140. Each module 140 may include pre-existing, pre-coded functionality that is already compatible with source code 112, which may be copied and pasted or otherwise plugged into source code 112. For example, each module 140 include functionality frequently requested by users, which has already been developed and coded with module code 141. In some embodiments, modules 140 may include functionality that has been added by FGS 102 for other users 110. The module code 141 may include the pre-generated, pre-tested, code for a particular module 140, in a programming language that is the same as or otherwise compatible with source code 112.

In some embodiments, each module 140 may also include or be associated with metadata 130. Metadata 130 may include information about the module 140 that may be relevant to selecting the module 140 in a vector search. In some embodiments, the metadata 130 may indicate the functionality supported by the module 140, the date created, the name of the creator, the size of the module code 141, or any other relevant information. For simplicity, metadata 130 and module code 141 are only illustrated for module 140A, but it is understood that module 140B may include similar features as those described with respect to module 140A. If a module 140 includes functionality that has been added by FGS 102 for another user in response to a request 116 from that user, then metadata 130 may include the original request 116 submitted by that user.

As noted above, in some embodiments, FGS 102 may perform a vector search which returns any identified relevant module(s) 140 in a search result 143. In some embodiments, FGS 102 may perform the vector search, rather than requesting LLM 104 to perform the vector search because there may proprietary module code 141 that would be exposed if provided to a publicly available LLM 104 for searching/processing. As such, FGS 102 may perform the vector search as a way of improving security and confidentiality of the data stored in vector database 150.

One of the challenges of using a module 140, is that the module 140 may not include all the functionality requested by the user 110 in request 116. For example, the user 110 may submit a request 116 that is very specific to a user’s special circumstances, such as a particular document, file, or project. Thus, module code 141 may not include this functionality, but may include similar functionality. Or for example, the module 140 may however include a piece or portion of the functionality requested by the user 110, or different modules 140 may include different pieces of functionality requested by the user 110. As such prompt generator 124 may generate a code prompt 138 for LLM 104 to help fill in this gap between the existing module code 141 and the requested functionality. In some embodiments, LLM 104 may be specifically trained to develop code for source code 112 (e.g., following a similar formatting structure, using the same libraries, naming conventions, etc.).

In some embodiments, search result 143 may include multiple modules 140A, 140B each of which may be relevant to the requested functionality as identified by vector 127 (corresponding to the user request 116). In some embodiments, FGS 102 may provide the user 110 the option of selecting one or more of the modules 140 included in the search results 143 to use in application 108. Then the selected module 140 may be used to generate new code 106.

In some embodiments, the display of search results 143, as provided to user 110 via user interface 118, may include metadata 130 describing the functionality of each module 140. In some embodiments, the user 110 may select one of the modules 140 of the search results 143 and indicate that it has all the required functionality. If the user 110 indicates that a selected module 140 includes the required functionality, the no additional new code 106 may need to be generated, and the module code 141 may be implemented into source code 112. However, if there is still additional functionality required by the user 110, not already included in an existing module 140, then FGS 102 may generate new code 106 to fill in the gap.

Code prompt 138 may be a prompt, generated by prompt generator 124, to request new code 106 from LLM 104, corresponding to request 116. In some embodiments, prompt generator 124 may provide the request 116 (or vector 1247) the search result 143 (e.g., and/or the module(s) 140 selected by the user 110) as input for the code prompt 126, and request new code 106 as output from the LLM 104. The input may also include the corresponding module code 141 and metadata 130 for the identified module(s) 140. The new code 106 may include any revisions to be added to module code 141. In some embodiments, the new code 106 may include deleting or modifying a copy of existing module code 141.

In some embodiment, if search result 143 includes multiple identified modules 140, then in some embodiments, LLM 104 may select any one of the identified modules 140 of search result 143 that is most closely related to the request 116, and generate new code 106 accordingly. In other embodiments, LLM 104 may generate new code 106 for each of the modules 140 identified in search result 143.

In some embodiments, LLM 104 may receive or generate a copy (of at least a portion) of source code 112, and the new code 106 may be generated and integrated into the copy of source code 112. Copying the source code 112 (to another location or computing device local to user 110) may avoid potential issues that would otherwise arise from directly modifying source code 112 of application 108.

In some embodiments, FGS 102 may receive the new code 106 from LLM 104, and provide the new code 106 in a code preview 132 window in user interface 118. The code preview 132 may include the new code 106 that has been generated in accordance with code prompt 138 and responsive to the request 116. In some embodiments, preview 132 may include the original (or copy) of module code 141 in a first color, and the new code 106 (including any modifications or deletions to module code 141) in a second, different color. In some embodiments, the preview 132 may include the original source code 112 (which may be unchanged, and which may appear in a third, different color). In some embodiments, preview 132 may be displayed within the user interface 118.

In some embodiments, user 110 may approve the preview 132 or submit a modification 134. Modification 134 may include any user submitted change to the new code 106 as provided in preview 132. Modification 134 may include adding additional code and/or removing or modifying the new code 106. In some embodiments, user 110 my request to bypass the code preview 132 altogether. In some embodiments, the modification 134 may be limited to the copy of module code 141 and new code 106, but may not include a modification to source code 112.

In some embodiments, if there are several different versions of new code 106 (e.g., for each of several different modules 140 from search result 143), then the user 110 may be prompted to select which new code 106 to use for the application 108.

As noted above, the user 110 may be a non-technical user who does not have much background with coding or computer programming. Thus understating the code provided in preview 132 may be difficult. In some embodiments, the user 110 may request an interpretation 152 of the new code 106. The interpretation 152 may include a plain language description or explanation of what the new code 106 does line-by-line, or section-by-section. In some embodiments, the interpretation 152 may be integrated within new code 106 as comments for the user 110. In some embodiments, this interpretation 152 may be removed upon user approval of the new code 106.

In some embodiments, prompt generator 124 may generate a translate prompt 142. The translate prompt 142 may request that LLM 104 generates an interpretation 152 for the new code 106. In some embodiments, the translate prompt 142 may be integrated within the code prompt 138, and the resultant new code 106 may include the interpretation 152 without a subsequent translate prompt 142 request.

Upon receiving approval of new code 106, or a modification 134, FGS 102 may generate a simulation 136. Or, for example, if user 110 opts to bypass code preview 132, the new code 106 may be directly integrated into a local copy of source code 112 (e.g., whereby the original source code 112 may be modified to include or point to new code 106, which may include the original module code 141) as part of generating a simulation 136.

Simulation 136 may include a local or test execution of application 108 with the new functionality of new code 106 (and any approved modification 134) for user 110 to interact with or play with. Simulation 136 may include a compilation and execution of a local copy of source code 112 with new code 106, but may not impact or change the original source code 112 or application 108. Simulation 136 may allow the user 110 to test the application 108 with the new functionality as integrated by new code 106 and a selected module 140.

In some embodiments, simulation 136 may include a local update to a copy of the source code 112, accessible only to user 110. For example, as noted above, application 108 may be a network-accessible or cloud-based application 108. Rather than update the cloud-version or live version of the application 108, FGS 102 may update a local copy or local version of the application 108 only for user 110. The updated local version may include the new code 106, and any modification 134, generated in accordance with update request 116. The user 110 may then have the option to either reject or accept the simulation 136.

If user 110 rejects simulation 136, then FGS 102 may discard the local version of application 108 (e.g., including the new code 106), and source code 112 of the production version of application 108 may remain unchanged. If user approves simulation 136, then FGS 102 may integrate the new code 106 into source code 112. In some embodiments, the user 110 may schedule the update for a specific date/time in the future.

In some embodiments, FGS 102 may maintain different versions of source code 112 (or application 108). For example, user 110 may only be authorized to update a first version of application 108 which the user 110 is accessing, such that the new code 106 or update corresponding to update request 116 is not visible to any other users of application 108. However, there may be multiple additional versions of application 108 which are accessible to other users, which are unaffected by the deployment of new code 106 to the first version 144 of application 108.

In some embodiments, FGS 102 may maintain a list of tenants who are accessing a particular version of application 108. Tenants 146 may include any number of end users who are accessing a particular version 144 of application 108. For example, user 110 may be the manager for or member of a division within an organization with six employees. Even though the application 108 may be used by all one hundred members of the organization, the update of new code 106, as made by user 110, may only be accessible by the six members of the same team or division, each of whom may be a tenant of the same version.

In some embodiments, with proper authorization, the user 110 may submit a subsequent update request 116 for FGS 102 to update all the versions of application 108 for all tenants. This may include prompt generator 124 generating a new finalize prompt, asking LLM 104 to propagate the new code 106 to all the versions of application 108 (e.g. that user 110 is authorized to update). In some embodiments, the test phase and simulation 136 may be skipped in these subsequent updates since the new code 106 has already been tested and integrated into an existing version of application 108. In some embodiments, the finalize prompt may indicate which version(s) of application 108 is to be updated with the new code 106.

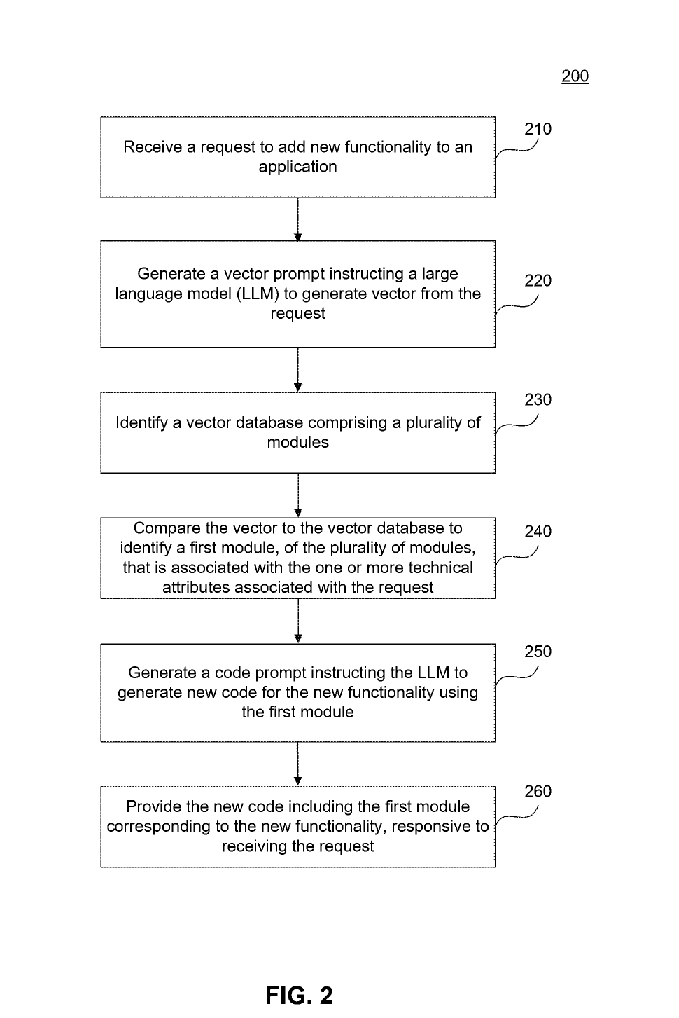

FIG. 2 is a flowchart 200 illustrating example operations for providing a functional code generation system (FGS) 102, according to some embodiments. Method 200 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 2, as will be understood by a person of ordinary skill in the art. Method 200 shall be described with reference to FIG. 1.

In 210, a request to add new functionality to an application is received via a user interface. For example, FGS 102 may receive request 116 from user 110. The request 116 may include a plain language request to add new functionality to an application 108.

In 220, a vector prompt is generated for a large language model (LLM), instructing the LLM to generate a vector from the request. For example, prompt generator 124 may generate a vector prompt 126. The vector prompt 126 may include the request 116 as input and request, as output, a vector 127 including one or more technical attributes extracted or derived from the request 116.

In some embodiments, LLM 104 may be configured to identify keywords corresponding to the technical attributes. In some embodiments, the vector prompt 126 may include a list of keywords extracted from metadata 130 of the various modules 140. In some embodiments, through its own natural language processing, LLM may identify or derive a set of technical attributes referenced by the request 116. For example, if request 116 indicates “Add copy functionality to copy an image from application 1 to application 2”, the derived technical attributes of vector 127 may include “copy, paste, cut, application 1, application 2”. As may be noted, “paste” and “cut” may be derived from the request 116, because they are related to or similar to “copy”.

In 230, a vector database comprising a plurality of modules is identified. For example, FGS 102 may identify vector database 150, which may include modules 140, each module corresponding to a new function or functionality to be added to application 108. Each of the modules 140 may include metadata 130 describing the technical attributes and/or description of the new functionality being added through module 140, and module code 141 which may include code written across one or more computing languages which is compatible with source code 112.

In 240, the vector is compared to the vector database to identify a first module, of the plurality of modules, that is associated with the one or more technical attributes associated with the request. For example, FGS 102 may compare vector 127 to the metadata 130 of the modules 140 stored in vector database 150 to generate search results 143. The search results 143 may include one more modules 140 from vector database 150 that correspond to or match most closely with vector 127.

In 250, a code prompt is generated for the LLM, instructing the LLM to generate new code for the new functionality using the first module. For example, prompt generator 124 may generate a code prompt 138. In some embodiments, the code prompt 138 may include the search results 143 as input, and request new code 106 as output. In some embodiments, the code prompt 138 may instruct the LLM 104 to maximize the reuse of module code 141 from the module(s) 140 in the search results 143, in order to satisfy the request 116 (which may be included as input with the code prompt 138).

LLM 104 may then generate new code 106 which may include portion(s) of module code 141 across one or more modules 140 in search results 143, and may include modifications to the module code 141 (e.g., with new lines of code, reordering code, removing existing code, etc.). In some embodiments, new code 106 may be integrated within source code 112, and may include a portion of source code 112.

In 260, providing, via the user interface, the new code including the first module corresponding to the new functionality, responsive to receiving the request. For example, FGS 102 may provide a preview 132 include the new code 106 (which may include source code 112). The user 110 may submit a modification 134 to the new code, or approve the new code 106. Upon receiving user modification 134 and/or approval, the new code 106 (including any submitted modification 134) may be integrated into application 108 for use by user 110. In some embodiments, FGS 102 may generate a test environment or simulation 136 where the user 110 may test the application 108 with the new code 106 (and any submitted modification), before approving or rejecting the changes.

In some embodiments, FGS 102 may manage different versions of application 108 (and its corresponding source code), such that if two different users each add their own functionality to application 108, each user is only presented with the functionality they added.

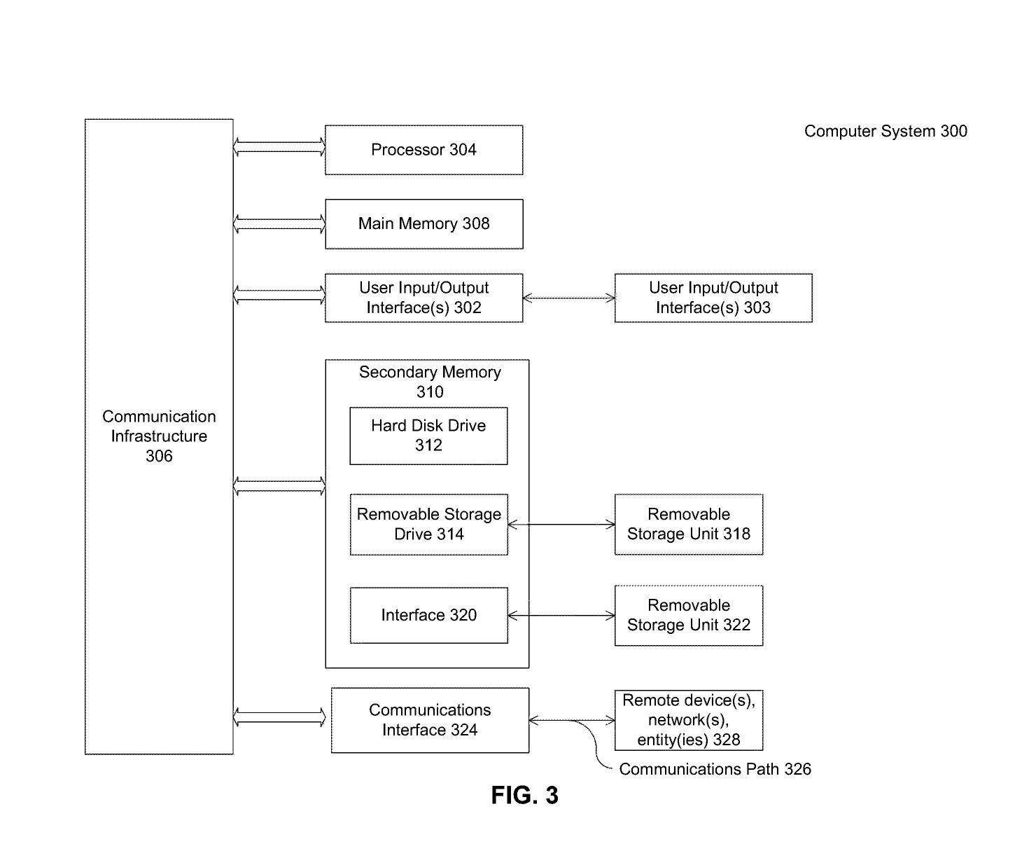

Various embodiments may be implemented, for example, using one or more well-known computer systems, such as computer system 300 shown in FIG. 3. One or more computer systems 300 may be used, for example, to implement any of the embodiments discussed herein, as well as combinations and sub-combinations thereof.

Computer system 300 may include one or more processors (also called central processing units, or CPUs), such as a processor 304. Processor 304 may be connected to a communication infrastructure or bus 306.

Computer system 300 may also include user input/output device(s) 303, such as monitors, keyboards, pointing devices, etc., which may communicate with communication infrastructure 306 through user input/output interface(s) 302.

One or more of processors 304 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 300 may also include a main or primary memory 308, such as random access memory (RAM). Main memory 308 may include one or more levels of cache. Main memory 308 may have stored therein control logic (i.e., computer software) and/or data.

Computer system 300 may also include one or more secondary storage devices or memory 310. Secondary memory 310 may include, for example, a hard disk drive 312 and/or a removable storage device or drive 314. Removable storage drive 314 may be a floppy disk drive, a magnetic tape drive, a compact disk drive, an optical storage device, tape backup device, and/or any other storage device/drive.

Removable storage drive 314 may interact with a removable storage unit 318. Removable storage unit 318 may include a computer usable or readable storage device having stored thereon computer software (control logic) and/or data. Removable storage unit 318 may be a floppy disk, magnetic tape, compact disk, DVD, optical storage disk, and/ any other computer data storage device. Removable storage drive 314 may read from and/or write to removable storage unit 318.

Secondary memory 310 may include other means, devices, components, instrumentalities or other approaches for allowing computer programs and/or other instructions and/or data to be accessed by computer system 300. Such means, devices, components, instrumentalities or other approaches may include, for example, a removable storage unit 322 and an interface 320. Examples of the removable storage unit 322 and the interface 320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 300 may further include a communication or network interface 324. Communication interface 324 may enable computer system 300 to communicate and interact with any combination of external devices, external networks, external entities, etc. (individually and collectively referenced by reference number 328). For example, communication interface 324 may allow computer system 300 to communicate with external or remote devices 328 over communications path 326, which may be wired and/or wireless (or a combination thereof), and which may include any combination of LANs, WANs, the Internet, etc. Control logic and/or data may be transmitted to and from computer system 300 via communication path 326.

Computer system 300 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 300 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 300 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 300, main memory 308, secondary memory 310, and removable storage units 318 and 322, as well as tangible articles of manufacture embodying any combination of the foregoing. Such control logic, when executed by one or more data processing devices (such as computer system 300), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 3. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method, comprising:
receiving, via a user interface, a request to add new functionality to an application;
generating a vector prompt for a large language model (LLM), wherein the LLM is configured to generate a vector from the request, and wherein the vector comprises one or more technical attributes associated with the request;
identifying a vector database comprising a plurality of modules, wherein each of the plurality of modules is associated with adding a new function to the application;
comparing, by one or more processors, the vector to the vector database to identify a first module, of the plurality of modules, that is associated with the one or more technical attributes associated with the request;
generating a code prompt for the LLM, wherein the code prompt includes both the request and the first module, and wherein the LLM is configured to generate new code for the new functionality using the first module; and
providing, via the user interface, the new code including the first module corresponding to the new functionality, responsive to receiving the request.

2. The computer-implemented method of claim 1, wherein the comparing comprises performing a similarity search returning two or more modules of the plurality of modules that correspond to the new functionality, wherein the two or more modules include the first module.

3. The computer-implemented method of claim 2, wherein the code prompt includes the two or more modules, and wherein the LLM is configured to select the first module of the two or more modules that most closely resembles the new functionality.

4. The computer-implemented method of claim 1, further comprising:
receiving, via the user interface, one or more updates to the new code from a user.

5. The computer-implemented method of claim 1, further comprising:
receiving user approval on the new code; and
modifying application code, corresponding to the application, with the new code, wherein upon a subsequent use of the application, the new functionality as corresponding to the new code is available.

6. The computer-implemented method of claim 1, further comprising:
receiving a translate request responsive to the new code;
generating a translate prompt for the LLM, wherein responsive to the translate prompt, the LLM is configured to generate a plain language interpretation of the new code; and
providing, via the user interface, both the new code and the plain language interpretation for display.

7. The computer-implemented method of claim 1, wherein the new code includes module code as corresponding to the first module.

8. A system comprising:
a memory; and
at least one processor coupled to the memory and configured to perform operations comprising:
receiving, via a user interface, a request to add new functionality to an application;
generating a vector prompt for a large language model (LLM), wherein the LLM is configured to generate a vector from the request, and wherein the vector comprises one or more technical attributes associated with the request;
identifying a vector database comprising a plurality of modules, wherein each of the plurality of modules is associated with adding a new function to the application;
comparing, by one or more processors, the vector to the vector database to identify a first module, of the plurality of modules, that is associated with the one or more technical attributes associated with the request;
generating a code prompt for the LLM, wherein the code prompt includes both the request and the first module, and wherein the LLM is configured to generate new code for the new functionality using the first module; and
providing, via the user interface, the new code including the first module corresponding to the new functionality, responsive to receiving the request.

9. The system of claim 8, wherein the comparing comprises performing a similarity search returning two or more modules of the plurality of modules that correspond to the new functionality, wherein the two or more modules include the first module.

10. The system of claim 9, wherein the code prompt includes the two or more modules, and wherein the LLM is configured to select the first module of the two or more modules that most closely resembles the new functionality.

11. The system of claim 8, the operations further comprising:
receiving, via the user interface, one or more updates to the new code from a user.

12. The system of claim 8, the operations further comprising:
receiving user approval on the new code; and
modifying application code, corresponding to the application, with the new code, wherein upon a subsequent use of the application, the new functionality as corresponding to the new code is available.

13. The system of claim 8, the operations further comprising:
receiving a translate request responsive to the new code;
generating a translate prompt for the LLM, wherein responsive to the translate prompt, the LLM is configured to generate a plain language interpretation of the new code; and
providing, via the user interface, both the new code and the plain language interpretation for display.

14. The system of claim 8, wherein the new code includes module code as corresponding to the first module.

15. A non-transitory computer-readable medium having instructions stored thereon that, when executed by at least one computing device, cause the at least one computing device to perform operations comprising:
receiving, via a user interface, a request to add new functionality to an application;
generating a vector prompt for a large language model (LLM), wherein the LLM is configured to generate a vector from the request, and wherein the vector comprises one or more technical attributes associated with the request;
identifying a vector database comprising a plurality of modules, wherein each of the plurality of modules is associated with adding a new function to the application;
comparing, by one or more processors, the vector to the vector database to identify a first module, of the plurality of modules, that is associated with the one or more technical attributes associated with the request;
generating a code prompt for the LLM, wherein the code prompt includes both the request and the first module, and wherein the LLM is configured to generate new code for the new functionality using the first module; and
providing, via the user interface, the new code including the first module corresponding to the new functionality, responsive to receiving the request.

16. The non-transitory computer-readable medium of claim 15, wherein the comparing comprises performing a similarity search returning two or more modules of the plurality of modules that correspond to the new functionality, wherein the two or more modules include the first module.

17. The non-transitory computer-readable medium of claim 16, wherein the code prompt includes the two or more modules, and wherein the LLM is configured to select the first module of the two or more modules that most closely resembles the new functionality.

18. The non-transitory computer-readable medium of claim 15, the operations further comprising:
receiving, via the user interface, one or more updates to the new code from a user.

19. The non-transitory computer-readable medium of claim 15, the operations further comprising:
receiving user approval on the new code; and
modifying application code, corresponding to the application, with the new code, wherein upon a subsequent use of the application, the new functionality as corresponding to the new code is available.

20. The non-transitory computer-readable medium of claim 15, the operations further comprising:
receiving a translate request responsive to the new code;
generating a translate prompt for the LLM, wherein responsive to the translate prompt, the LLM is configured to generate a plain language interpretation of the new code; and
providing, via the user interface, both the new code and the plain language interpretation for display.
